(19) United States
(12) Patent Application Publication
(10) Pub. No.: US 2015/0086089 A1
(43) Pub. Date: Mar. 26, 2015

(54) PERSONAL SECURITY SYSTEM AND METHOD

(71) Applicants: THEODORE J. SATLOFF, NEW YORK, NY (US); JAMES E. SATLOFF, NEW YORK, NY (US)

(72) Inventors: THEODORE J. SATLOFF, NEW YORK, NY (US); JAMES E. SATLOFF, NEW YORK, NY (US)

(21) Appl. No.: 14/061,778

(22) Filed: Oct. 24, 2013

Related U.S. Application Data
(60) Provisional application No. 61/881,092, filed on Sep. 23, 2013.
(60) Provisional application No. 61/881,092, filed on Sep. 23, 2013.

(51) Int. Cl. G06K 9/00

(52) U.S. Cl. CPC G06K 9/00154
USPC 382/119

(57) ABSTRACT

A system automatically verifies the authenticity of a manually handwritten symbol entered into a computer or other electronic device by a user writing on an electronic tablet or pad. After a symbol is entered, a logic device determines whether the sensing locations and points in time associated with sensing the imprint of this symbol on the tablet substantially match respective sensing locations and points in time associated with the imprint of one of the previously stored original handwritten symbols. Preferably, the sensors are arranged in a prescribed line pattern, for example that of a square, immediately beneath the writing surface of the tablet, and sense the intersections of the imprint with the line pattern.

### CROSS-REFERENCE TO RELATED APPLICATION

This application claims priority from the provisional application No. 61/881,092, filed Sep. 23, 2013.

### BACKGROUND OF THE INVENTION

The present invention concerns an apparatus and method for automatically verifying the authenticity of manually handwritten symbols or characters entered into a computer or other electronic device by a user writing, drawing or otherwise making a virtual marking en an electronic tablet or pad.

Handwritten signatures on paper documents such as contracts and bank checks have been known and used for authentication purposes for well over two hundred years. This system has worked well because it is fairly easy for a person to tell if his or her signature has been forged. Also handwriting experts are able to tell, with a high degree of certainty, whether a handwritten signature is genuine. However, with the increasing volume of payment transactions over time the careful scrutiny of signatures by financial institutions has proven unworkable.

Within the past thirty years or so, systems have been developed and used by financial institutions to automatically check and recognize whether a signature on a document, purported to be made by an account holder, is or is not genuine. For example, neural circuits have been devised to identify forged signatures on bank checks and credit or debit card receipts. With such systems, it has at least been possible to flag questionable signatures so that, in such cases, an account holder can be contacted to confirm whether a given transaction was authorized.

This type of automated security system has been extended to include “signature pads” at point of sale (“POS”) devices for payment with credit and debit cards (“payment cards”) for authentication purposes to ensure that the payment card user is, in fact, the payment card owner.

Existing systems call for “swiping” or inserting a payment card in a card reader, or for holding the face of the card toward a reader, to identify the bank account (the bank, the account number and the account holder) of the purchaser of goods or services. Usually when the amount to be paid is over a given threshold, for example $30 or more, the POS device requires the signature of the account holder to authorize payment. The account holder then signs his or her name on an electronic tablet or pad using a stylus provided for this purpose and presses an “enter” button to complete the transaction. In this case, if the user's signature is relatively long or convoluted, it is often difficult for him or her to write it accurately on the tablet or pad.

As used herein, the term “electronic tablet or pad,” or simply “tablet” is intended to include any electronic device which senses the input a line drawing including, without limitation, the trackpad of a laptop computer, the touch-sensitive display screen of a personal computer (“PC”), the touch surface of a handheld device such as a personal digital assistant (“PDA”), the face of a pad computer such as an iPad® or Surface® or that of a smartphone, in addition to the writing surface provided on a point of sale (“POS”) device.

Consequently, even with this automation, financial institutions have found that it is often less expansive to absorb the cost of fraudulent transactions than to check for false signatures. The signatures entered on the writing surface of a tablet are often merely recorded but not checked to ensure that they are genuine. Fraudulent transactions are allowed to proceed at the expense of the account holders if left undiscovered and at the expense of financial Institution which must make restitution if an account holder discovers and reports the fraud.

### SUMMARY OF THE INVENTION

The principal objective of the present invention is to provide a system for authorizing financial transactions which has an increased level of security over the current, well-known systems for account holder authentication by signature review and recognition.

Another objective of the present invention is to accurately and securely recognize a single character or “pictogram,” manually entered on the writing surface of an electronic tablet or pad, that is simpler and easier to enter than a personal signature, Such a character or pictogram (hereafter called a “handwritten symbol”) may be a drawing of any type or style which, unlike a signature, need have no relationship to a user's identity (e.g., the user's name or social security number). For use in making a payment the handwritten symbol must have been previously created by the user and entered into the system in advance of using a payment card in a transaction.

These objectives, as well as other objectives which will become apparent from the discussion that follows, are achieved, in accordance with the present invention, by providing an apparatus, and a method for using an apparatus, which includes the following elements:

(a) A tablet having a writing surface and a plurality of tablet sensors, arranged below the surface, for detecting line drawing contacts with the surface made by a user while forming an imprint of a manually handwritten symbol;

(b) A memory for storing the successive locations of the tablet sensors that detected the imprints of a number of “original” handwritten symbols, manually drawn by different users, and for storing successive points in time at which such tablet sensors detected such imprints; and

(c) A logic device, coupled to the tablet and to the memory, for comparing:
(1) the successive sensor locations and points in time associated with an imprint of a putative-original handwritten symbol sensed while a uses draws the putative handwritten symbol on the tablet, and
(2) the locations and points in time stored in memory for the imprint of at least one of the plurality of original handwritten symbols.

The logic device determines whether the respective locations and points in time associated with the imprint of the putative handwritten symbol substantially match the locations and points in time associated with the imprint of one of the original handwritten symbols.

When the user first enters a drawing of the original handwritten symbol in the system, he or she may be asked to draw the same symbol multiple times, so as to create an acceptable range of slight variations in inputs for storage in memory. Later, at the POS, the user must then enter a drawing that closely matches the original handwritten symbols stored in memory to create a match.

The drawing entered at the POS—namely, the putative handwritten symbol—is analyzed based on each sensor's location in the coordinates of the writing surface of the tablet. Preferably, an outline of a box line pattern (which may be square, round, or some other configuration) or a grid line pattern is printed on the writing surface of the tablet to act as a guide for the user. The user attempts to match the location and frequency at which the lines of the drawing forming the handwritten symbol intersect lines of the line pattern. If the user fails to enter the handwritten symbol correctly, authorization for the payment card is denied.

To further increase the level of security, the tablet not only identifies the locations of the sensors which detect the line drawings forming the imprints of the handwritten symbols, but also the successive points in time that the contacts with the writing surface are sensed. This feature prevents a user from fraudulently authorizing payment by carefully tracing out the imprint of an original handwritten symbol with the aid of a stencil. The successive points in time are measured with respect to the time that the user initially contacts the tablet to draw the handwritten symbol, be it the original handwritten symbol or the putative original, so that the basis of measurement will be the same for both.

The handwritten symbol may be cursively written with a continuous contact with the surface of the tablet while forming the imprint. Preferably, however, the symbol may be drawn with a number of line segments or strokes on the tablet surface. In this case the system memory further stores the points in time at which contact with the surface of the tablet is initiated and subsequently removed, while forming the imprint of an original handwritten symbol, for later comparison with the corresponding points in time for the imprint of a putative handwritten symbol.

To still farther increase the level of security, the tablet not only identifies the locations of the sensors which detect the line drawings forming the imprints of the manually handwritten symbols, and possibly also the successive points in time that the contacts with the writing surface are sensed, but also the amount of force applied by the contacts with the writing surface to form the imprints of the handwritten symbols. This feature prevents a user from fraudulently authorizing payment by freehand copying of the imprint of an original handwritten symbol.

The present invention also provides a method for automatically verifying the authenticity of manually handwritten symbols entered into a computer or other electronic device by a user writing on a tablet. This method essentially comprises the steps of:

(a) manually drawing sample imprinters of original handwritten symbols on a surface of an electronic tablet having sensors arranged below said surface for detecting line drawing contacts with surface;

(b) storing the successive locations of the tablet sensors that detected the imprints of a plurality of original handwritten symbols, manually drawn by different users, and storing successive points in time at which such tablet sensors detected such imprints;

(c) manually drawing an imprint of a putative-original handwritten symbol on a surface of a writing tablet having sensors arranged below said surface for detecting line drawing contacts with the surface;

(d) storing successive locations of the tablet sensors that detected the imprint and storing successive points in time at which such sensors detected the imprint;

(e) comparing (1) the successive sensor locations and points in time associated with the imprint of the putative handwritten symbol, and (2) the locations and points in time stored in memory for the imprint of at least one of said plurality of original handwritten symbols; and

(f) determining whether the respective locations and points in time associated with the imprint of the putative handwritten symbol substantially matches the locations and points in time associated with the imprint of one of the original handwritten symbols, so as to automatically verify or disprove the authenticity of the putative handwritten symbol.

The system (the apparatus and the method) according to the present invention may be implemented as a mandatory system for all users of payment cards, or it may be chosen by a payment card holder as an optional safety measure to ensure authenticity of any person attempting to use the card.

For a full understanding of the present invention, reference should now be made to the following detailed description of the preferred embodiments of the invention as illustrated in the following drawings.

### BRIEF DESCRIPTION OF THE DRAWINGS

FIG. 1 is a block diagram of the system according to the present invention for automatically verifying the authenticity of manually handwritten symbols.

FIG. 2 is diagram showing the display of a POS terminal requesting entry of payment card information.

FIG. 3 is a diagram showing the display of the POS terminal of FIG. 2 requesting entry of an account holder's signature on a designated writing area.

FIG. 4 is a diagram showing the display of the POS terminal of FIG. 3 requesting entry of an account holder's handwritten symbol on a designated writing area.

FIG. 5 is a diagram of the imprint of an original handwritten symbol drawn on a designated writing area, showing the points of intersection of the line forming the symbol with the outline of a square box within the writing area.

FIG. 6 is a diagram showing the imprint of a putative-original handwritten symbol drawn on the designated writing area of the POS terminal of FIG. 4 so as to intersect with the outline of the square box.

FIG. 7 is a diagram, similar to FIG. 6, indicating that the putative handwritten symbol is being authenticated.

FIG. 8 is a diagram showing points of intersection between the line forming the putative handwritten symbol and the outline of the square box, indicating where matches are found with respective intersections of the original handwritten symbol.

FIG. 9 is a diagram showing the putative handwritten symbol drawn on the designated writing area of the POS terminal of FIG. 6, after access is denied.

FIGS. 10a, 10b and 10c are representative diagrams showing possible arrangements of sensors arranged below the writing surface of a POS terminal.

### DETAILED DESCRIPTION OF THE PREFERRED EMBODIMENTS

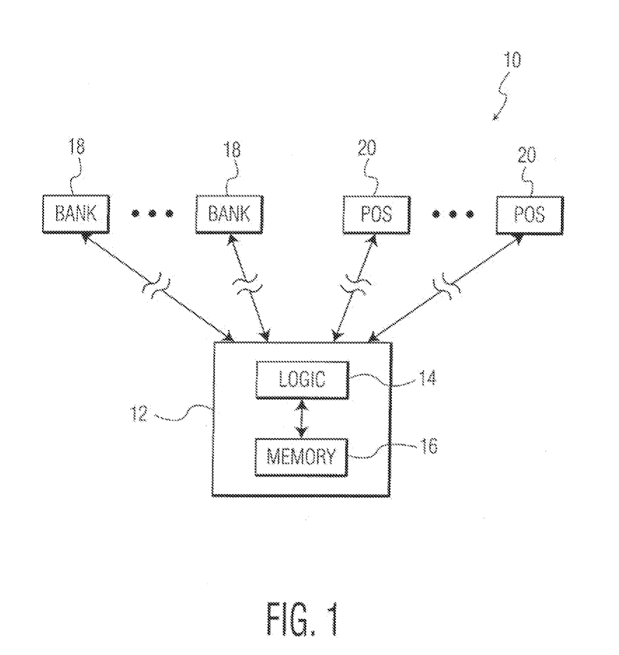

The preferred embodiments of the present invention will now be described with reference to FIGS. 1-10 of the drawings. Identical elements in the various figures are identified with the same reference numerals.

FIG. 1 is a block diagram of the system 10 according to the invention having a central computer 12 with a logic device (CPU) 14 and memory 16. The central computer communicates wirelessly or through landlines via the Internet, an intranet, an Ethernet, telephone lines or the like with a plurality of terminals 18 and 20 each having a screen or tablet with a touch-sensitive writing surface. These terminals may be found at financial institutions, at point of sale (POS) locations, homes, offices or anywhere else. Certain terminals, such as those at banks, may be used to enter handwritten symbols which form “originals” for storage and later comparison with putative originals entered by user either at the same or other terminals.

The tablet of each terminal has a plurality of sensors, integrated with or arranged below the writing surface, for detecting the line drawing contacts with the surface made by a user while forming an imprint of a manually handwritten symbol. When a given sensor detects contact with the surface immediately above it, two items if information are transmitted to the central computer 12:

(1) the location of the sensor, and

(2) the time that the sensor detects the contact.

The time stamp associated with a sensor is preferably a time duration measured with respect to the time that the user first- makes contact with the tablet surface when writing a symbol. This is advantageous to minimize the number of digits required to specify the time.

Terminals 18 located in banks and other financial institutions may be used to enter “original” handwritten symbols for later comparison with putative originals entered by users to verify their identity. Terminals 20 at other places, such as at points of sale, may be used to enter the putative originals.

When the central computer 12 receives information detected from writing an original handwritten symbol on a tablet, it stores in the memory 16 the successive locations of the tablet sensors that detected the imprint and stores the successive points in time at which these sensors detected the imprint. When the computer 12 receives information detected from writing a symbol which is a supposed (putative) original, the CPU 14 compares (1) the successive sensor locations and points in time associated with the imprint of the putative-original, sensed while a user draws the symbol on the tablet, with (2) the locations and points in time stored in memory for the imprint of one or more of the original handwritten symbols.

The CPU determines whether the respective locations and points in time associated with the imprint of the putative handwritten symbol substantially match the locations and points in time associated with the imprint of one of the original handwritten symbols. If no substantial match is found, the financial transaction attempted by the user is denied.

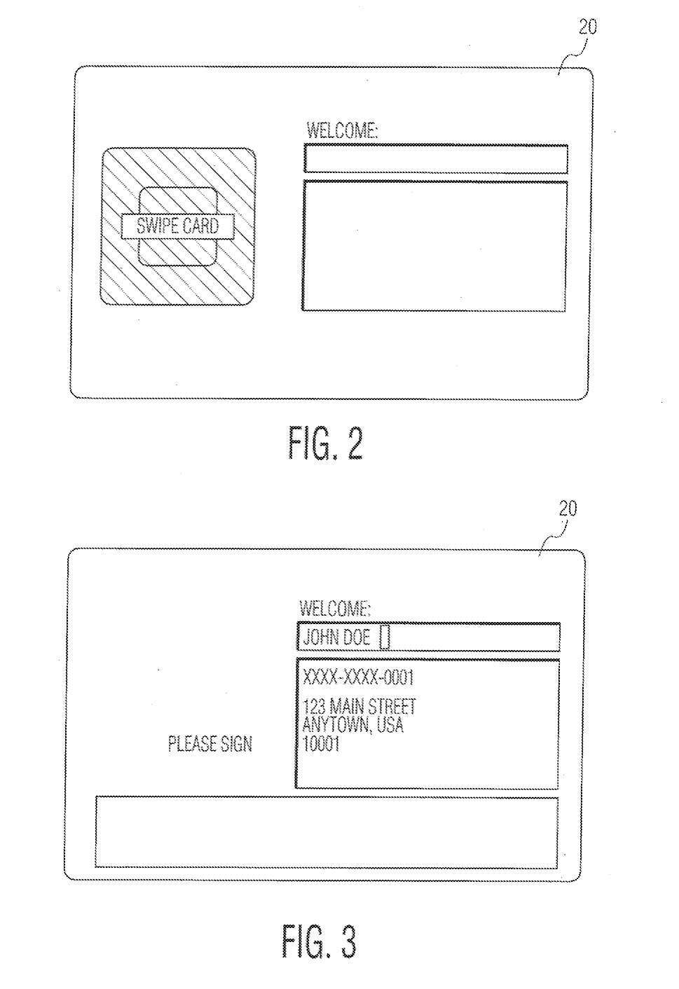

A typical front panel of one of the terminals 20 at a point of sale is represented in FIG. 2. Once the sales person has entered the transaction information (e.g. by scanning a bar code on the item to be purchased), the terminal tablet prompts the user (the buyer in this case) to swipe his or her payment card.

Next the POS terminal prompts the user to enter a signature as shown in FIG. 3. Once the user has done so, the transaction is verified and, in the normal course, the user's account is charged.

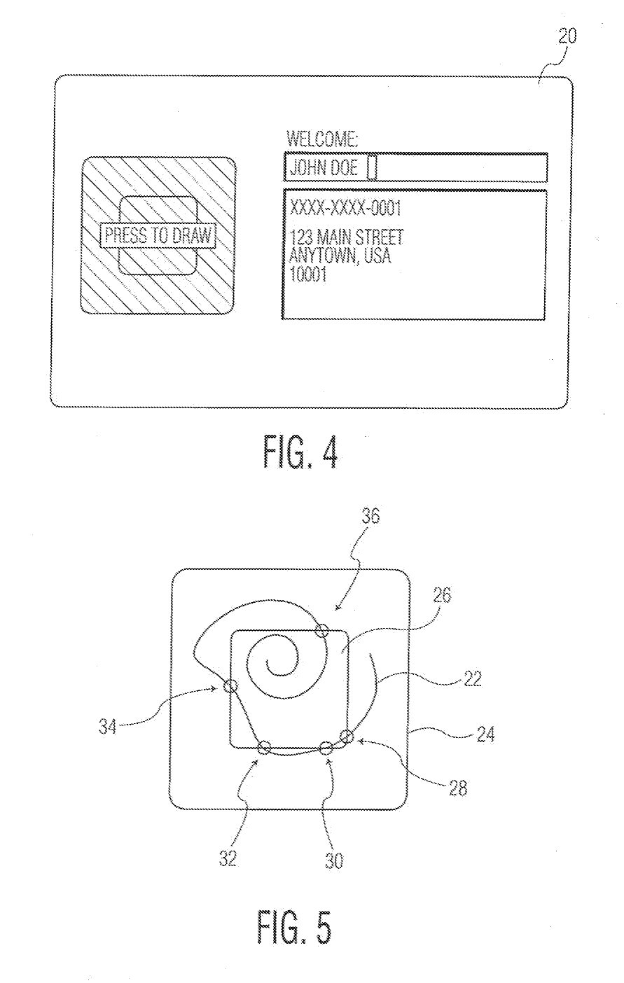

According to the present invention, another level of security is added by prompting the user to draw his or her personal handwritten symbol, as shown in FIG. 4. This symbol may be a single character or letter in some known language of the world, or some arbitrary drawing or “pictogram” created by the user. Preferably, the symbol is net a standard character which can readily be discovered and duplicated, but rather an arbitrary symbol newly created by the user to provide additional security for his or her financial transactions.

FIG. 5 illustrates such an arbitrary symbol 22. In this case it has been cursively written as a single unbroken line, maintaining contact between the stylus and the tablet while writing. The symbol could also have been written with one or more separate “strokes,” lifting the stylus from the tablet between strokes, as would occur when writing the capital letter “H” or a Chinese character for example.

In FIG. 5 a line forming an original symbol 22 has been entered on a tablet writing area within the border 24. Beneath the surface of the writing area are rows of sensors, arranged side by aide along a single line forming a closed loop 26 in the shape of a square parallelepiped or “box.” The intersections of the line forming the symbol 22 with the line of sensors 26 are indicated by the arrows 28, 30, 32, 34 and 36. The sensors at these points of intersection successively detect the contacts with the surface of the tablet as the line is drawn by the user, starting first with the sensor at intersection 28 and progressing to the sensor at the intersection 36. Both the locations of these sensors, and the points in time at which the sensors detect the imprint of the symbol, are transmitted to the central computer 12 for storage in the memory 16.

The points in time are measured with respect to a time t0 when a sensor, for example the sensor at 23, first detects a line contact with the tablet surface. The subsequent points in time are registered successively as times t1 for the sensor at 30, time t2 for the sensor at 32, and so forth.

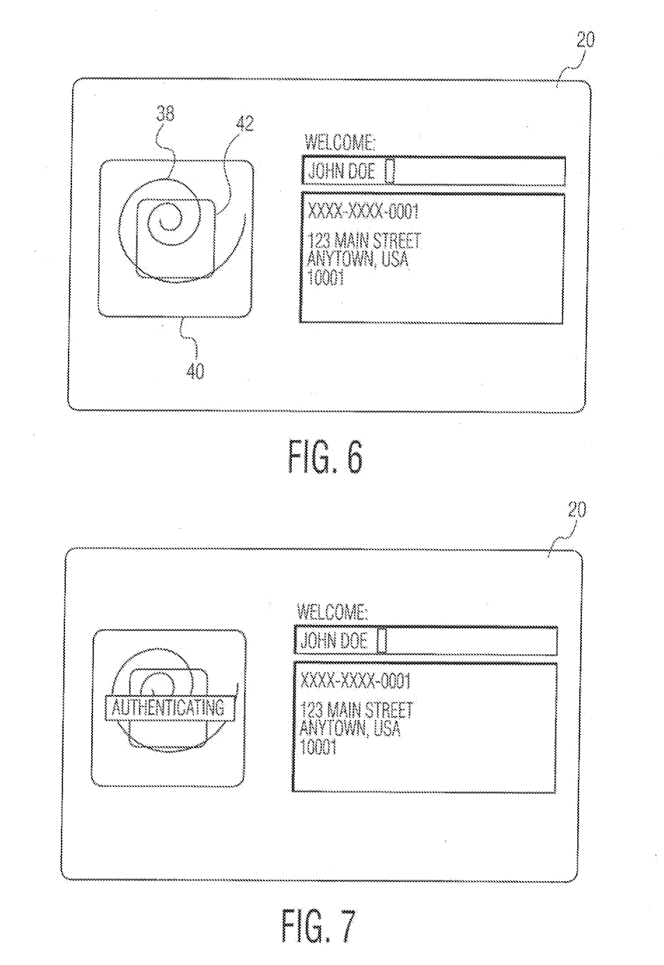

FIG. 6 shows a different symbol 38 which has been entered by a user as a putative-original in the writing area 40 of the point of sale terminal. The closed loop line 42 shown on the writing area acts as a guide for the user while drawing the symbol. The sensors arranged below the surface along this line 42 detect intersections with the imprint of the symbol 38 as the line forming this symbol is drawn.

After the user enters the symbol 38 he or she is prompted to press an “Enter” button. After doing so the sensor locations and the points in time that the sensors detect the “window crossings” with the box 42 are transmitted to the central computer 12. The CPU 14 then attempts to authenticate the putative-original symbol using “fuzzy logic,” for example by means of a neural network. The POS terminal may indicate that the authentication, is “in process” by displaying a message, as is shown in FIG. 7.

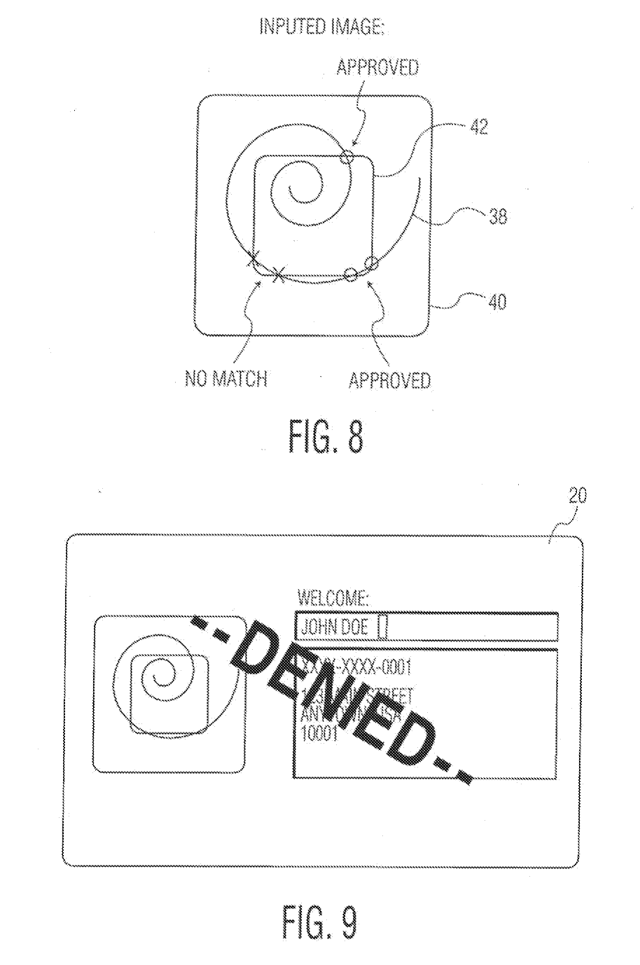

In the present case, the window crossings of the inputted symbol are not all sufficiently matched, as is indicated in FIG. 8. Although some points of intersection of the lines 38 and 42 are sufficiently close to those of the original symbol 22 to pass muster, some are different so the CPU 14 must continue its processing to make a “pass” or “fail” decision. Assisting in making this decision are the attempted matches of the points in time, which indicate whether the intersections of the putative symbol 38 with the boar line 42 were made in the same order and whether the entire symbol was written with approximately the same speed as was the original symbol 22.

In the present example, the CPU 14 makes a determination that the putative symbol was not written by the account holder and it denies authorization to make payment. The transaction is therefore terminated before the user's account is charged.

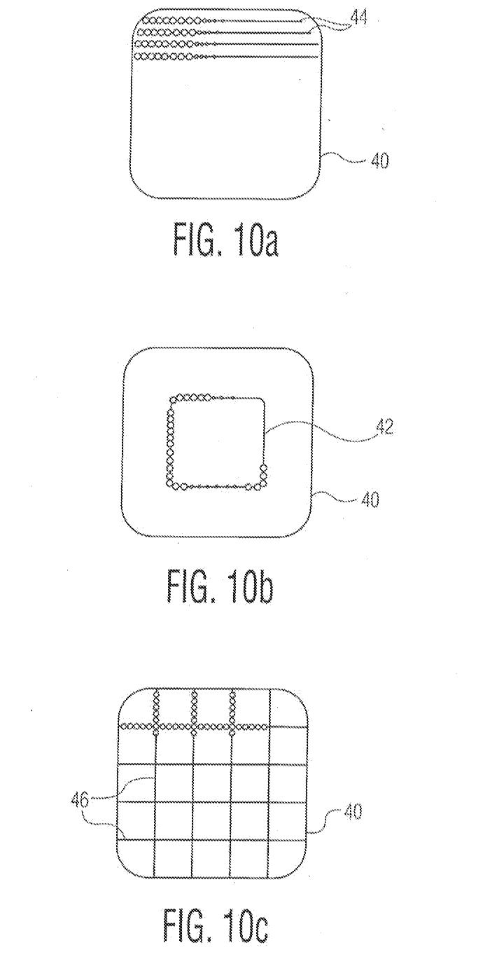

FIG. 10 shows three examples of sensors disposed in a writing area on the writing surface of a tablet. FIG. 10(a) shows a conventional arrangement with the sensors arranged closely together in rows 44 to form a “raster.” FIG. 10(b) shows the arrangement used in the embodiment of FIGS. 2-9 and described above, in which the sensors are aligned in a closed loop 42 forming a square box. Finally, FIG. 10(c) Shows an embodiment in which the sensors are arranged along lines 46 of a rectangular grid. Other arrangements of sensors are of course possible as well.

There has thus been shown end described an improved personal security system and method which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. An apparatus for automatically verifying the authenticity of manually handwritten symbols entered into a computer or other electronic device by a user writing on a tablet, said apparatus comprising:
(a) a tablet having a writing surface and a plurality of tablet sensors, arranged below said surface, for detecting line drawing contacts with said surface made by a user while forming an imprint of a manually handwritten symbol;
(b) a memory for storing the successive locations of tablet sensors that detected the imprints of a plurality of original handwritten symbols, manually drawn by different users, and for storing successive points in time at which such tablet sensors detected such imprints; and
(c) a logic device, coupled to said tablet and to said memory, for comparing (1) the successive sensor locations and points in time associated with an imprint of a putative-original handwritten symbol sensed while a user draws the putative handwritten symbol on the tablet, and (2) the locations and points in time stored in memory for the imprint of at least one of said plurality of original handwritten symbols, and
for determining whether the respective locations and points in time associated with the imprint of said putative handwritten symbol substantially match the locations and points in time associated with the imprint of said one of said original handwritten symbols.

2. The apparatus defined in claim 1, wherein said tablet sensors further sense the amount of force applied by said contacts with said surface of said tablet to form said imprints of said manually handwritten symbols; wherein said memory stores the forces detected for the imprints of said original handwritten symbols; and wherein said logic device compares (1) the forces associated with the imprint of a putative-original handwritten symbol with (2) the forces stored in memory for the imprint of at least one of said plurality of original handwritten symbols, and for determining whether the forces associated with the imprint of the putative handwritten symbol substantially matches the stored forces associated with the imprint of said one of said original handwritten symbols.

3. The apparatus defined in claim 1, wherein said sensors are arranged in a prescribed pattern on said tablet.

4. The apparatus defined in claim 3, wherein said pattern is a rectangular grid formed of intersecting straight lines and the sensors are arranged along said grid lines.

5. The apparatus defined in claim 3, wherein said pattern is a rectangular parallopiped and the sensors are arranged along a line forming the parallelepiped.

6. The apparatus defined in claim 5, wherein the pattern is a square box.

7. The apparatus defined in claim 1, wherein the successive points in time that the tablet sensors detect the surface contacts made while forming the imprint of said putative handwritten symbol are measured relative to the time of sensing at least one other surface contact made while forming the imprint of said putative handwritten symbol.

8. The apparatus defined in claim 7, wherein the successive points in time that the tablet sensors detect the surface contacts made while forming the imprint of said putative handwritten symbol are measured relative to the time of sensing the first surface contact made while forming the imprint of said putative handwritten symbol.

9. The apparatus defined in claim 1, wherein said manually handwritten symbols are cursively written with a continuous contact with the surface of the tablet while forming the imprints thereof.

10. The apparatus defined in claim 1, wherein said memory further stores the points in time at which a contact with the surface of the tablet is removed, while forming an imprint of each original handwritten symbol, with respect to the time of sensing the first surface contact made while forming the imprint of said original handwritten symbol.

11. The apparatus defined in claim 10, wherein said manually handwritten symbols are written in segments, and wherein said memory further stores the successive points in time at which a contact with the surface of the tablet is made and thereafter removed, respectively, at the beginning and at the end of each segment, measured with respect to the time of sensing the first contact with the surface made while forming the imprint of said original handwritten symbol.

12. An apparatus for sensing the authenticity of manually handwritten symbols entered into a computer or other electronic device by a user writing on a tablet, said apparatus comprising:
(a) a tablet having a writing surface and a plurality of tablet sensors, arranged below said surface in a prescribed line pattern, for detecting line drawing contacts with said surface made by a user while forming an imprint of a manually handwritten symbol, said writing surface having imprinted thereon said line pattern which serves as a guide for the user in writing the handwritten symbol, whereby the lines forming the imprint of the handwritten symbol are sensed when they intersect the line pattern;
(b) a memory for storing the successive locations of tablet sensors that detected the imprints of a plurality of original handwritten symbols manually drawn by different users; and
(c) a logic device, coupled to said tablet and to said memory, for comparing (1) the successive sensor locations associated with an imprint of a putative-original handwritten symbol sensed while a user draws the putative handwritten symbol on the tablet, and (2) the sensor locations stored in memory for the imprint of at least one of said plurality of original handwritten symbols, and for determining whether the respective locations associated with the imprint of said putative handwritten symbol substantially matches the sensor locations associated with the imprint of said one of said original handwritten symbols.

13. The apparatus defined in claim 3, wherein said line pattern is a rectangular grid formed of intersecting straight lines.

14. The apparatus defined in claim 3, wherein said line pattern is a rectangular parallopiped.

15. The apparatus defined in claim 5, wherein said line pattern is a square.

16. A method for automatically verifying the authenticity of manually handwritten symbols entered into a computer or other electronic device by a user writing on a tablet, said method comprising the steps of:
(a) manually drawing sample imprints of original handwritten symbols on a surface of a writing tablet having a plurality of sensors arranged below said surface for detecting line drawing contacts with surface;
(b) storing the successive locations of the tablet sensors that detected the imprints of a plurality of original handwritten symbols, manually drawn by different users, and storing successive points in time at which such tablet sensors detected such imprints;
(c) manually drawing an imprint of a putative-original handwritten symbol on a surface of a writing tablet having a plurality of sensors arranged below said surface for detecting line drawing contacts with the surface;
(d) storing successive, locations of the tablet sensors that detected the imprint and storing successive points in time at which such sensors detected the imprint;
(e) comparing (1) the successive sensor locations and points in time associated with the imprint of the putative handwritten symbol, and (2) the locations and points in time stored in memory for the imprint of at least one of said plurality of original handwritten symbols; and
(f) determining whether the respective locations and points in time associated with the imprint of said putative handwritten symbol substantially matches the locations and points in time associated with the imprint of said one of said original handwritten symbols, thereby to automatically verify or disprove the authenticity of the putative handwritten symbol.
